(19) United States
(12) Patent Application Publication
(10) Pub. No.: US 2010/0176598 A1
(43) Pub. Date: Jul. 15, 2010

(54) Wind power generator structure

(76) Inventors: Cheng Tzu Huang, Taipei (TW); Tsung-Yuan Ku, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,976

(22) Filed: Jan. 14, 2009

(51) Int. Cl. F03D 9/00; F03B 17/04

(52) U.S. Cl. 290/55; 415/916

(57) ABSTRACT

A wind power generator structure includes a wind power generating module, a man-made wind generating module, a hollow receiving module and a wind-guiding module. The wind power generating module has a generator set and a fan pivoted on the generator set. The man-made wind generating module has a man-made wind generator. The man-made wind generator has an outlet facing the fan, and an external power device supplies a power source to the man-made wind generator for generating wind that passes through the outlet. The hollow receiving module has a hollow receiving casing, and the hollow receiving casing has an inlet portion and an outlet portion respectively formed on its inlet side and outlet side. The fan is received in the hollow receiving casing, and the wind-guiding module has a wind-guiding tube communicating with the outlet of the man-made wind generator and the inlet portion of the hollow receiving casing.

### BACKGROUND OF THE INVENTION

1. Field of the Invention

The present invention relates to a wind power generator structure, and particularly relates to a wind power generator structure using at least one man-made wind generator.

2. Description of Related Art

With the change in global climate and calls for environmental protection, more and more countries recognize that the energy sources in the earth are diminishing and thus gradually take renewable energies into consideration to serve as primary energy sources in the future since they are clean, emit low greenhouse gases and belong to indigenous energy. In view of this, our government's energy policy is to gradually develop renewable energy.

Wind power generation has already been one of the options of renewable energies to be developed. The wind power is clean without generating any pollution. Further, in comparison with thermal power or nuclear power, since the source of wind power is inexhaustible natural wind, it can generate power without utilizing the conversion of substances. At earlier stages, the cost of the wind power generation was too large and the thus-generated amount of electricity was insufficient. However, with the continuous progress in the technique of power generation and the set of generators made of newly developed materials, the current set of wind power generators can achieve high efficiency. Moreover, the space occupied by the set of wind power generators is so small that it is a cost-effective way of power generation.

Although the technique of wind power generation has already well developed to be used as a renewable energy, it is still difficult to become popular in daily life in view of the current state of the art. Since most sets of wind power generators are fixedly provided at appropriate sites to perform power generation, a set of wind power generators is designed to be immobile and thus cannot be manually carried like the structure of traditional generators. Therefore, even though wind power generation has advantage of high efficiency and no pollution, the mobility of the traditional generators still cannot be substituted.

Another defect of the wind power generation of the prior art is that the blowing power and the flow direction of the wind cannot be controlled. Hence, when the blowing power is weak and the flow direction is incorrect, the wind power generation cannot achieve good work efficiency. Therefore, the effectiveness of the wind power generation of the prior art is limited by time (such as reason and weather) and space (such as landscape shape and position).

### SUMMARY OF THE INVENTION

One particular aspect of the present invention is to provide a wind power generator structure. The advantage of the wind power generator structure is not only to be independent of time (such as season and weather conditions) and space (such as landscape shapes and position), but also the wind power generator structure can work without continuously receiving external power supply.

In order to achieve the above-mentioned aspects, the present invention provides a wind power generator structure, including: a wind power generating module and a man-made wind generating module. The wind power generating module has at least one generator set and at least one fan pivoted on the generator set. The man-made wind generating module has a man-made wind generator. The man-made wind generator has an outlet facing the fan, and an external power device supplies a power source to the man-made wind generator in order to generate wind that passes through the outlet.

The present invention has the following advantages: The effectiveness of the wind power generator structure not only is independent of time (such as season and weather conditions) and space (such as landscape shapes and position), but also the wind power generator structure can work without continuously receiving external power supply. Moreover, the wind power generator structure can be selectably assembled or disassembled, so the wind power generator structure is a portable power generator.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawings, in which:

FIG. 1 is a function block of a wind power generator structure according to the first embodiment of the present invention;

FIG. 2 is a function block of a wind power generator structure according to the second embodiment of the present invention;

FIG. 3 is a function block of a wind power generator structure according to the third embodiment of the present invention;

FIG. 4 is a function block of a wind power generator structure according to the fourth embodiment of the present invention;

FIG. 5 is a function block of a wind power generator structure according to the fifth embodiment of the present invention;

FIG. 6 is a function block of a wind power generator structure according to the sixth embodiment of the present invention;

FIG. 7 is a function block of a wind power generator structure according to the seventh embodiment of the present invention;

FIG. 8 is a function block of a wind power generator structure according to the eighth embodiment of the present invention;

FIG. 9 is a function block of a wind power generator structure according to the ninth embodiment of the present invention; and

FIG. 10 is a function block of a wind power generator structure according to the tenth embodiment of the present invention.

### DETAILED DESCRIPTION OF PREFERRED EMBODIMENTS

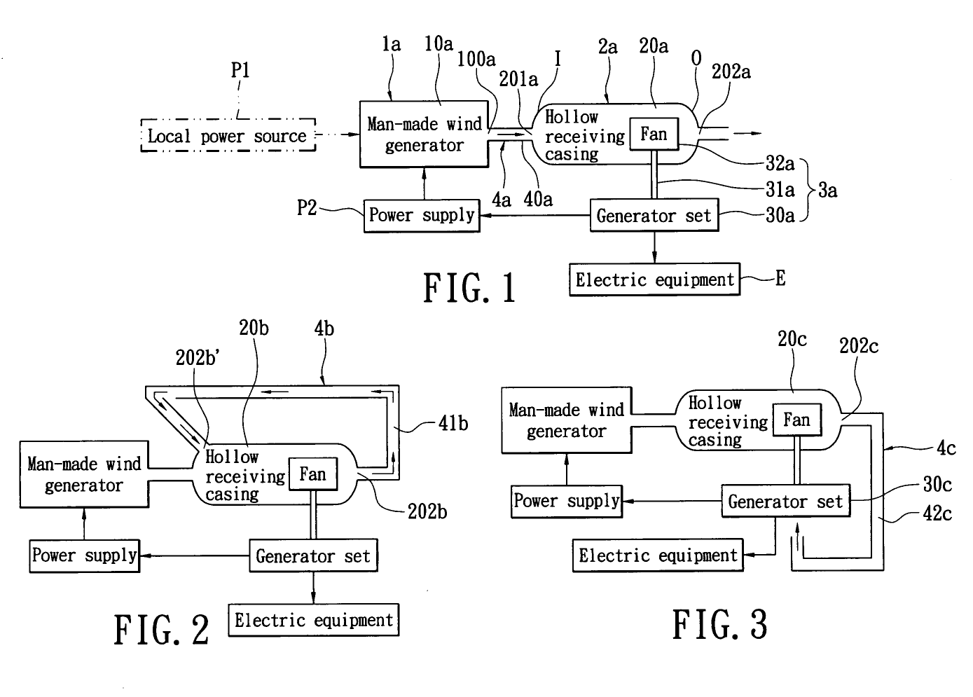

Referring to FIG. 1, the first embodiment of the present invention provides a wind power generator structure, including: a man-made wind generating module 1a, a hollow receiving module 2a, a wind power generating module 3a and a wind-guiding module 4a.

The man-made wind generating module 1a has a man-made wind generator 10a, and the man-made wind generator 10a has an outlet 100a. An external power device supplies a power source to the man-made wind generator 10a in order to generate wind (such as the arrow in FIG. 1) that passes through the outlet 100a. The external power device can be a local power source P1 or a power supply P2 disposed outside the man-made wind generator 10a. In the first embodiment, the man-made wind generator 10a can be an air compressor. However, the air compressor is just an example, and any type of machine that can generate wind is protected by the present invention.

The hollow receiving module 2a has at least one hollow receiving casing 20a, and the hollow receiving casing 20a has an inlet portion 201a and an outlet portion 202a respectively formed on its inlet side I and outlet side O.

The wind power generating module 3a has at least one generator set 30a, a pivot shaft 31a, and at least one fan 32a pivoted on the generator set 30a. The generator set 30a is electrically connected to at least one electric equipment E in order to supply power to the electric equipment E, and the generator set 30a is electrically connected to the power supply P2 in order to indirectly supply power to the man-made wind generator 10a. The fan 32a can be a centrifugal fan, an axial fan or a radial fan, and the outlet 100a of the man-made wind generator 10a faces the fan 32a. In other words, the pivot shaft 31a is connected between the generator set 30a and the fan 32a, so that the fan 32a drives the generator set 30a by the pivot shaft 31a in order to transform mechanical energy into electric energy. In the first embodiment, the fan 32a can be received in the hollow receiving casing 20a, and the generator set 30a is disposed outside the hollow receiving casing 20a. However, the feature of the fan 32a received in the hollow receiving casing 20a and the generator set 30a disposed outside the hollow receiving casing 20a are just an example and does not limit the present invention.

Moreover, the wind-guiding module 4a has a wind-guiding tube 40a communicating with the outlet 100a of the man-made wind generator 10a and the inlet portion 201a of the hollow receiving casing 20a. In the first embodiment, the wind-guiding tube 40a can be a straight tube that has the same tube diameter. However, the straight tube just an example and does not limit the present invention. The wind-guiding tube of any type or any size can be protected by the present invention.

Hence, the man-made wind generator 10a is started by the local power source P1 or the power supply P2 in order to generate wind. The wind is transmitted to the hollow receiving casing 20a by the wind-guiding tube 40a, and then the wind blows the blades of the fan 32a to rotate the blades of the fan 32a in order to drive the generator set 30a to generate power that can be stored in the generator set 30a or can supply to the man-made wind generator 10a. Finally, the wind is discharged from the outlet portion 202a of the hollow receiving casing 20a to external world (shown as the arrow in the FIG. 1).

Referring to FIG. 2, the difference between the second embodiment and the first embodiment is that: in the second embodiment, the wind-guiding module 4b has a loop communicating tube 41b communicating between the outlet portion 202b of the hollow receiving casing 20b and a second inlet portion 202b′ formed on the inlet side of the hollow receiving casing 20b, so that wind circulates between the hollow receiving casing 20b and the loop communicating tube 41b (shown as the arrow in FIG. 2).

Referring to FIG. 3, the difference between the third embodiment and above-mentioned embodiments is that: in the third embodiment, the wind-guiding module 4c has a heat-dissipating communicating tube 42c. One end of the heat-dissipating communicating tube 42c is communicated with the outlet portion 202c of the hollow receiving casing 20c, and another end of the heat-dissipating communicating tube 42c faces the generator set 30c, so that wind is blown out from the another end of the heat-dissipating communicating tube 42c to the generator set 30c in order to dissipate heat from the generator set 30c (shown as the arrow in FIG. 3).

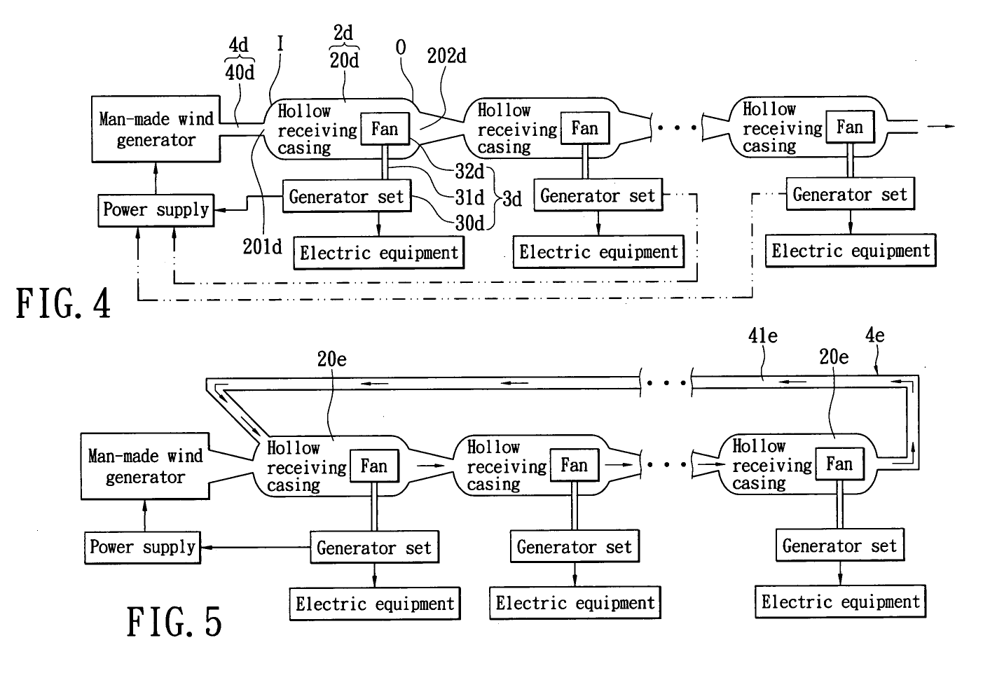

Referring to FIG. 4, the difference between the fourth embodiment and the first embodiment is that: in the fourth embodiment, the hollow receiving module 2d has a plurality of hollow receiving casings 20d, and the wind-guiding module 4d has a plurality of wind-guiding tubes 40d. Each hollow receiving casing 20d has an inlet portion 201d and an outlet portion 202d respectively formed on its inlet side I and outlet side O, and each wind-guiding tube 40d is communicated between two hollow receiving casings 20d in order to serially connected the hollow receiving casings 20d together. In addition, the first one of the wind-guiding tube 40d is a straight tube that has the same tube diameter, and other wind-guiding tubes 40d are venture tubes. Each venture tube has a taper tube diameter, and each venture tube has an inlet portion and an outlet portion. The tube diameter of the inlet portion is larger than the tube diameter of the outlet, and the wind flows from the inlet portion to the outlet portion in order to increase the velocity of the wind in the hollow receiving casing 20d. Moreover, the wind power generating module 3d has a plurality of generator sets 30d, a plurality of pivot shafts 31d respectively corresponding to the generator sets 30d, and a plurality of fans 32d respectively pivoted on the generator sets 30d by the pivot shafts 31d. The fans 32d are respectively received in the hollow receiving casings 20d, and at least one of the generator sets is electrically connected to the supply power.

Referring to FIG. 5, the difference between the fifth embodiment and the fourth embodiment is that: in the fifth embodiment, the wind-guiding module 4e has a loop communicating tube 41e communicating between the first one of the hollow receiving casings 20e and the last one of the hollow receiving casings 20e, so that the wind circulates between the hollow receiving casings 20e and the loop communicating tube 41e (shown as the arrow in FIG. 5) to form a circulation system.

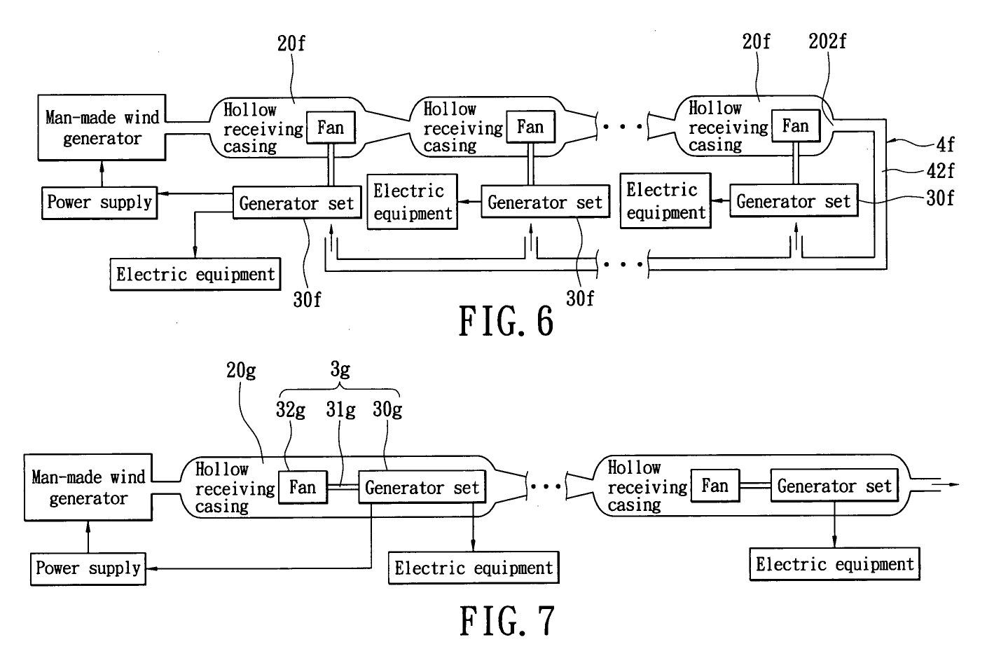

Referring to FIG. 6, the difference between the sixth embodiment and the fourth and the fifth embodiments is that: in the sixth embodiment, the wind-guiding module 4f has a heat-dissipating communicating tube 42f. One end of the heat-dissipating communicating tube 42f is communicated with the outlet portion 202f of the last one of the hollow receiving casings 20f, and another end sides of the heat-dissipating communicating tube 42f face the generator set 30f, so that wind is blown out from the another end sides of the heat-dissipating communicating tube 42f to the generator sets 30f in order to dissipate heat from the generator sets 30f (shown as the arrow in FIG. 6).

Referring to FIG. 7, the difference between the seventh embodiment and above-mentioned embodiments is that: in the seventh embodiment, each generator set 30g is received in each hollow receiving casing 20g. In other words, the generator set 30g, the pivot shaft 31g and the fan 32g of each wind power generating module 3g is received in the corresponding hollow receiving casing 20g. In addition, at least one of the generator sets 30g is electrically connected to the man-made wind generator in order to supply power to the man-made wind generator.

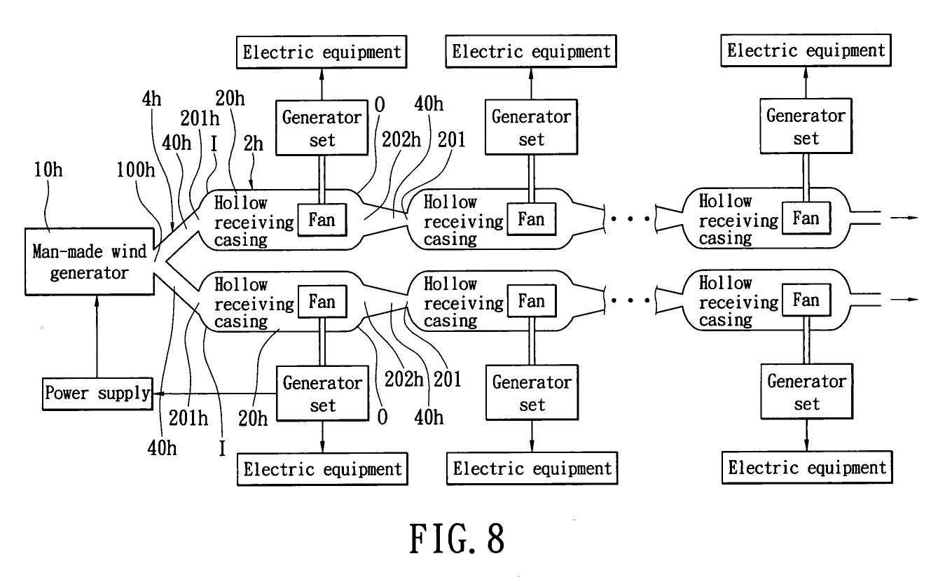

Referring to FIG. 8, the difference between the eighth embodiment and the fourth embodiment is that: in the eighth embodiment, the hollow receiving module 2h has a plurality of hollow receiving casings 20h, and the wind-guiding module 4h has a plurality of wind-guiding tubes 40h. Each hollow receiving casing 20h has an inlet portion 201h and an outlet portion 202h respectively formed on its inlet side I and outlet side O. The hollow receiving casings 20h are arranged in two rows. Each wind-guiding tube 40h is horizontally communicated between two hollow receiving casings 20h and one of the wind-guiding tube 40h is communicated from an outlet 100h of the man-made wind generator 10h to the first one of the hollow receiving casings 20h of one row and to the first one of the hollow receiving casings 20h of another row, in order to connect the hollow receiving casings 20h to form two serial rows.

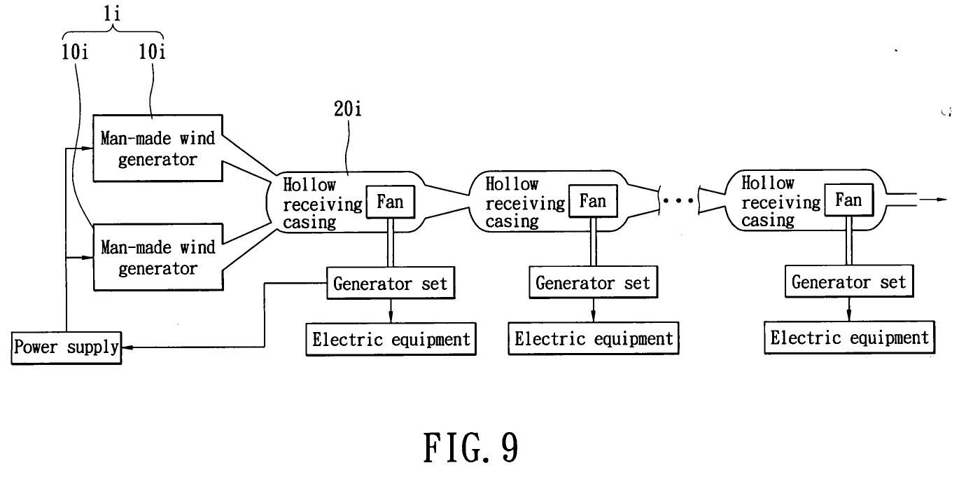

Referring to FIG. 9, the difference between the ninth embodiment and the fourth embodiment is that: in the ninth embodiment, the man-made wind generating module 1i includes two or more than two man-made wind generators 10i, so that the two or more than two man-made wind generators 10i can supply wind into the hollow receiving casing 20i together.

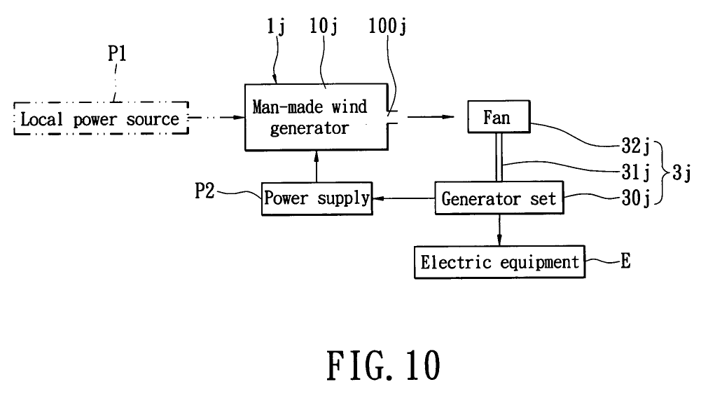

Referring to FIG. 10, the difference between the tenth embodiment and above-mentioned embodiments is that: the wind power generator structure of the tenth embodiment includes: a man-made wind generating module 1j and a wind power generating module 3j.

The man-made wind generating module 1j has a man-made wind generator 10j, and the man-made wind generator 10j has an outlet 100j. An external power device supplies a power source to the man-made wind generator 10j in order to generate wind (such as the arrow in FIG. 10) that passes through the outlet 100j. The external power device can be a local power source P1 or a power supply P2 disposed outside the man-made wind generator 10j. In the tenth embodiment, the man-made wind generator 10j can be an air compressor. However, the air compressor is just an example, and any type of machine that can generate wind is protected by the present invention.

The wind power generating module 3j has at least one generator set 30j, a pivot shaft 31j, and at least one fan 32j pivoted on the generator set 30j. The generator set 30j is electrically connected to at least one electric equipment E in order to supply power to the electric equipment E, and the generator set 30j is electrically connected to the power supply P2 in order to indirectly supply power to the man-made wind generator 10j. The fan 32j can be a centrifugal fan, an axial fan or a radial fan, and the outlet 100j of the man-made wind generator 10j faces the fan 32j. In other words, the pivot shaft 31j is connected between the generator set 30j and the fan 32j, so that the fan 32j drives the generator set 30j by the pivot shaft 31j in order to transform mechanical energy into electric energy.

Hence, the man-made wind generator 10j is started by the local power source P1 or the power supply P2 in order to generate wind, and then the wind blows the blades of the fan 32j to rotate the blades of the fan 32j in order to drive the generator set 30j to generate power that can be stored in the generator set 30j or can supply to the man-made wind generator 10j.

Although the present invention has been described with reference to the preferred best molds thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. A wind power generator structure, comprising:
a wind power generating module having at least one generator set and at least one fan pivoted on the generator set; and
a man-made wind generating module having a man-made wind generator, wherein the man-made wind generator has an outlet facing the fan, and an external power device supplies a power source to the man-made wind generator in order to generate wind that passes through the outlet.

2. The wind power generator structure as claimed in claim 1, wherein the man-made wind generator is an air compressor.

3. The wind power generator structure as claimed in claim 1, wherein the external power device is a local power source or a power supply disposed outside the man-made wind generator.

4. The wind power generator structure as claimed in claim 1, wherein the fan is a centrifugal fan, an axial fan or a radial fan.

5. The wind power generator structure as claimed in claim 1, further comprising: a hollow receiving module and a wind-guiding module, wherein the hollow receiving module has at least one hollow receiving casing, the hollow receiving casing has an inlet portion and an outlet portion respectively formed on its inlet side and outlet side, the fan is received in the hollow receiving casing, and the wind-guiding module has a wind-guiding tube communicating with the outlet of the man-made wind generator and the inlet portion of the hollow receiving casing.

6. The wind power generator structure as claimed in claim 5, wherein the man-made wind generating module further comprises another man-made wind generator, so that both the two man-made wind generators supply wind into the hollow receiving casing.

7. The wind power generator structure as claimed in claim 5, wherein the wind power generating module has a pivot shaft connected between the generator set and the fan, so that the fan drives the generator set by the pivot shaft in order to transform mechanical energy into electric energy.

8. The wind power generator structure as claimed in claim 7, wherein the generator set is disposed outside the hollow receiving casing or is received in the hollow receiving casing, and the generator set is electrically connected to the man-made wind generator in order to supply power to the man-made wind generator.

9. The wind power generator structure as claimed in claim 5, wherein the wind-guiding tube is a venture tube with a taper tube diameter, the venture tube has an inlet portion and an outlet portion, the tube diameter of the inlet portion is larger than the tube diameter of the outlet, and the wind flows from the inlet portion to the outlet portion in order to increase the velocity of the wind in the hollow receiving casing.

10. The wind power generator structure as claimed in claim 5, wherein the wind-guiding tube is a straight tube that has the same tube diameter.

11. The wind power generator structure as claimed in claim 5, wherein the wind-guiding module has a loop communicating tube communicating between the outlet portion of the hollow receiving casing and a second inlet portion formed on the inlet side of the hollow receiving casing, so that wind circulates between the hollow receiving casing and the loop communicating tube.

12. The wind power generator structure as claimed in claim 5, wherein the wind-guiding module has a heat-dissipating communicating tube, one end of the heat-dissipating communicating tube is communicated with the outlet portion of the hollow receiving casing, and another end of the heat-dissipating communicating tube faces the generator set, so that wind is blown out from the another end of the heat-dissipating communicating tube to the generator set in order to dissipate heat from the generator set.

13. The wind power generator structure as claimed in claim 5, wherein the hollow receiving module has a plurality of another hollow receiving casings, the wind-guiding module has a plurality of another wind-guiding tubes, each another hollow receiving casing has an inlet portion and an outlet portion respectively formed on its inlet side and outlet side, and each another wind-guiding tube is communicated between two hollow receiving casings in order to serially connected the whole hollow receiving casings together.

14. The wind power generator structure as claimed in claim 13, wherein the wind-guiding module has a loop communicating tube communicating between the hollow receiving casing and the last one of the another hollow receiving casings, so that the wind circulates between the whole hollow receiving casings and the loop communicating tube.

15. The wind power generator structure as claimed in claim 13, wherein the wind power generating module has a plurality of another generator sets and a plurality of another fans respectively pivoted on the another generator sets, and the another fans are respectively received in the another hollow receiving casings.

16. The wind power generator structure as claimed in claim 15, wherein the wind-guiding module has a heat-dissipating communicating tube, one end of the heat-dissipating communicating tube is communicated with the outlet portion of the last one of the another hollow receiving casings, and another end sides of the heat-dissipating communicating tube face the generator set and the another generator sets, so that wind is blown out from the another end sides of the heat-dissipating communicating tube to the whole generator sets in order to dissipate heat from the whole generator sets.

17. The wind power generator structure as claimed in claim 15, wherein the whole generator sets are respectively disposed outside the whole hollow receiving casings or are respectively received in the whole hollow receiving casings, and at least one of the whole generator sets is electrically connected to the man-made wind generator in order to supply power to the man-made wind generator.

18. The wind power generator structure as claimed in claim 5, wherein the hollow receiving module has a plurality of another hollow receiving casings, the wind-guiding module has a plurality of another wind-guiding tubes, each another hollow receiving casing has an inlet portion and an outlet portion respectively formed on its inlet side and outlet side, the whole hollow receiving casings are arranged in two rows, each another wind-guiding tube is horizontally communicated between each two of the whole hollow receiving casings and the wind-guiding tube is communicated from the outlet of the man-made wind generator to the first one of the another hollow receiving casings of one row, in order to connect the whole hollow receiving casings to form two serial rows.

19. The wind power generator structure as claimed in claim 1, wherein the generator set is electrically connected to at least one electric equipment in order to supply power to the electric equipment.
